(19) United States
(12) Patent Application Publication
(10) Pub. No.: US 2023/0223561 A1
(43) Pub. Date: Jul. 13, 2023

(54) FUEL CELL STACK AND METHOD FOR MANUFACTURE

(71) Applicant: PLUG POWER INC., Latham, NY (US)

(72) Inventor: Jon OWEJAN, Latham, NY (US)

(73) Assignee: PLUG POWER INC., Latham, NY (US)

(21) Appl. No.: 17/572,679

(22) Filed: Jan. 11, 2022

(51) Int. Cl. H01M 8/0232; H01M 8/0258; H01M 8/0267

(52) U.S. Cl. CPC H01M 8/0232; H01M 8/0258; H01M 8/0267

(57) ABSTRACT

A fuel cell system includes a first electrically non-conductive sheet portion having a coolant flow layer in an opening thereof, a first non-stamped, flat, metal separator on a first side of the coolant flow layer and a second non-stamped, flat, metal separator on a second side of the coolant flow layer opposite the first separator. A membrane is received in an opening of a second electrically non-conductive sheet portion. Gas diffusion layers are located on opposite sides of the membrane. The gas diffusion layers have channels open toward the first non-stamped, flat, metal separator or the second non-stamped, flat, metal separator to allow flow of an oxidant and/or fuel therethrough.

### TECHNICAL FIELD

The present invention relates, generally, to methods and systems for manufacturing a fuel cell stack, and more particularly, to systems and methods for manufacturing a fuel cell stack to minimize damage to a fuel cell stack system and increase an efficiency of a method for manufacture.

### BACKGROUND OF THE INVENTION

Fuel cells electrochemically convert fuels and oxidants to electricity and heat and can be categorized according to the type of electrolyte (e.g., solid oxide, molten carbonate, alkaline, phosphoric acid or solid polymer) used to accommodate ion transfer during operation. Moreover, fuel cell assemblies can be employed in many (e.g., automotive to aerospace to industrial to residential) environments, for multiple applications.

A Proton Exchange Membrane (hereinafter “PEM”) fuel cell converts the chemical energy of fuels, such as hydrogen, and oxidants, such as air, directly into electrical energy. The PEM is a sold polymer electrolyte that permits the passage of protons (i.e., H+ ions) from the “anode” side of the fuel cell to the “cathode” side of the fuel cell while preventing passage therethrough of reactant fluids (e.g., hydrogen and air gases). The Membrane Electrode Assembly (hereinafter “MEA”) is placed between two electrically conductive plates, each of which has a flow passage to direct the fuel to the anode side and oxidant to the cathode side of the PEM.

Two or more fuel cells may be connected together to increase the overall power output of the assembly. Generally, the cells are connected in series, wherein one side of a plate serves as an anode plate for one cell and the other side of the plate is the cathode plate for the adjacent cell. These are commonly referred to as bipolar plates (hereinafter “BPP”). Alternately, the anode plate of one cell is electrically connected to the separate cathode plate of an adjacent cell. Commonly these two plates are connected back to back and are often bonded together (e.g., bonded by adhesive, weld, or polymer). This bonded pair becomes as one, also commonly called a bipolar plate, since anode and cathode plates represent the positive and negative poles, electrically. Such a series of connected multiple fuel cells is referred to as a fuel cell stack. The stack typically includes means for directing the fuel and the oxidant to the anode and cathode flow field channels, respectively. The stack usually includes a means for directing a coolant fluid to interior channels within the stack to absorb heat generated by the exothermic reaction of hydrogen and oxygen within the fuel cells. The stack generally includes means for exhausting the excess fuel and oxidant gases, as well as product water.

The stack also includes an endplate, insulators, membrane electrode assemblies, gaskets, separator plates, electrical connectors and collector plates, among other components, that are integrated together to form the working stack designed to produce electricity. The different plates may be abutted against each other and connected to each other to facilitate the performance of particular functions.

Currently, the manufacture and assembly of fuel cells is a manually intensive process. Individual fuel cell components (e.g., bipolar fuel cell plates, membrane electrode assemblies, end plates, gas diffusion layers) require individual manufacturing processes followed by assembly of the various components together. Such assembly is a manually intensive and precise process where any number of accidents or imperfections can cause damage to a portion (e.g., a fuel cell plate or other component thereof) of the Fuel Cell stack such that the fuel cell stack may not have appropriate quality and must be discarded. For example, a bending of a fuel cell plate of a fuel cell stack could cause a short circuit such that an entire fuel cell stack could not be utilized.

Further, the manual nature of the machining and assembling of fuel cell stacks is inefficient compared to other manufacturing processes for related technologies, such as automobile or battery manufacturing, which may be more automated.

Thus, there is a need for improved fuel cell stacks and improved methods of manufacturing fuel cells that increase efficiencies and minimize damage to fuel cell components of an assembled fuel cell system.

### SUMMARY OF THE INVENTION

The present invention provides, in a first aspect, a first electrically non-conductive sheet portion having a coolant flow layer in an opening thereof, a first non-stamped, flat, metal separator on a first side of the coolant flow layer and a second non-stamped, flat, metal separator on a second side of the coolant flow layer opposite the first separator. A membrane electrode assembly is received in an opening of a second electrically non-conductive sheet portion. Gas diffusion layers are located on opposite sides of the membrane electrode assembly. The gas diffusion layers have channels open toward the first non-stamped, flat, metal separator or the second non-stamped, flat, metal separator to allow flow of an oxidant and/or fuel therethrough.

The present invention, in a second aspect, a fuel cell subassembly for use in forming a fuel cell stack which includes an electrically non-conductive sheet, a plurality of fuel cell component locations linearly spaced on the sheet. A first location of the plurality of fuel cell component locations includes a first sheet portion of the sheet with a first opening and metal separator on a first side of the sheet covering the opening, a coolant flow layer received in the first opening at the first location and a second separator on a second side of the sheet covering the first opening. A second location of the plurality of fuel cell component locations includes a membrane electrode assembly received in a second opening of the sheet. A first gas diffusion layer is located on a first side of the second opening and a second gas diffusion layer is located on a second side of the opening.

The present invention provides, in a third aspect, a method for use in manufacturing a fuel cell system which includes forming a plurality of openings in an electrically non-conductive sheet. The openings are linearly spaced on the sheet. A metal separator is located on a first side of the sheet covering a first opening in a first portion of the sheet. A coolant flow layer is located in the first opening. A second separator is located on a second side of the sheet covering the first opening. A membrane electrode assembly is located in a second opening in a second sheet portion of the sheet. A first gas diffusion layer is located on a first side of the second opening and a second gas diffusion layer is located on a second side of the second opening.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a block diagram of a fuel cell system in accordance with the invention;

FIG. 2 is a perspective view of a portion of a fuel cell of the fuel cell system of FIG. 1;

FIG. 3 is an exploded view of the fuel cell of the system of FIG. 2;

FIG. 4 is a close up schematic view of a portion of the fuel cell of the system of FIG. 3,

FIG. 5 is a schematic view of a manufacture of the system of FIG. 1 illustrating components thereof on a web;

FIG. 6 is a side view of a cutting of the web of FIG. 5 forming flow channels in the web;

FIG. 7 is a side view of a connection of a separator to a bottom of the web of FIG. 6 to form a cavity for receiving a coolant layer;

FIG. 8 is a side view of a coolant layer being received in the cavity of FIG. 7;

FIG. 9 is a side view of a membrane electrode assembly being attached to the top and bottom of the web of FIG. 8;

FIG. 10 is a side view of a connection of a second separator to the top of the web above the coolant layer FIG. 9;

FIG. 11 is a side view of a molding of a seal on the system of FIG. 10;

FIG. 12 is a top schematic view of the web of FIG. 10 receiving inputs of a plurality of other webs; and

FIG. 13 depicts a portion of a perspective view of a gas diffusion layer of FIG. 3.

### DETAILED DESCRIPTION OF THE INVENTION

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

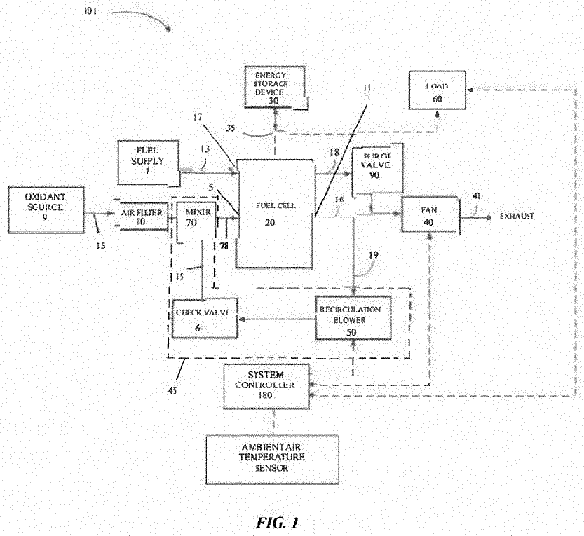

Thus, all the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with the principals of the present invention, fuel cell systems and methods for manufacturing a fuel cell stack are provided. In an example depicted in FIG. 1, a fuel cell system 101 is referred to as the assembled, or complete, system which functionally together with all parts thereof produces electricity and typically includes a fuel cell stack 20 and an energy storage device 30. The fuel cell is supplied with a fuel 13, for example, hydrogen, through a fuel inlet 17. Excess fuel 18 may be exhausted from the fuel cell through a purge valve 90 and may be diluted by a fan 40. In one example, fuel cell stack 20 may have an open cathode architecture of a PEM fuel cell, and combined oxidant and coolant, for example, air, may enter through an inlet air filter 10 coupled to an inlet 5 of fuel cell stack 20. Excess coolant/oxidant and heat may be exhausted from a fuel cell cathode of fuel cell stack 20 through an outlet 11 to fan 40 which may exhaust the coolant/oxidant and/or excess fuel to a waste exhaust 41, such as the ambient atmosphere. The fuel and coolant/oxidant may be supplied by a fuel supply 7 and an oxidant source 9 (e.g., air), respectively, and other components of a balance of plant, which may include compressors, pumps, valves, fans, electrical connections and sensors.

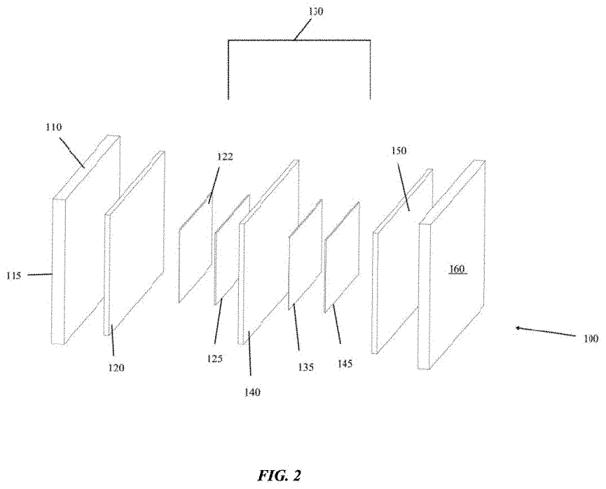

FIG. 2 depicts a schematic exploded view of an internal subassembly 100 of fuel cell stack 20 of FIG. 1 including a cathodic plate separator 110 at an outer end 115 and a plate separator seal 120 on an inner side thereof. A membrane electrode assembly (MEA) 130 is located between seal 120 and a second plate separator seal 150. An anode plate separator 160 is on a second end 165 of subassembly 100.

MEA 130 includes a membrane 140 (e.g., an ion conducting membrane) between a cathode side catalyst layer 125 and an anode side catalyst layer 135. A cathode side gas diffusion layer (GDL) 122 is located between cathode side catalyst layer 125 of the membrane electrode assembly and plate separator 110. An anode side gas diffusion layer 145 is located between anode side catalyst layer 135 of the membrane electrode assembly and plate separator 160. Seal 120 and seal 150 may be received in a channel of on an inner side of plate separator 110 and plate separator 160, respectively. In another example, such seals may be injection molded around an MEA (e.g., MEA 130) or another fuel cell component as described below.

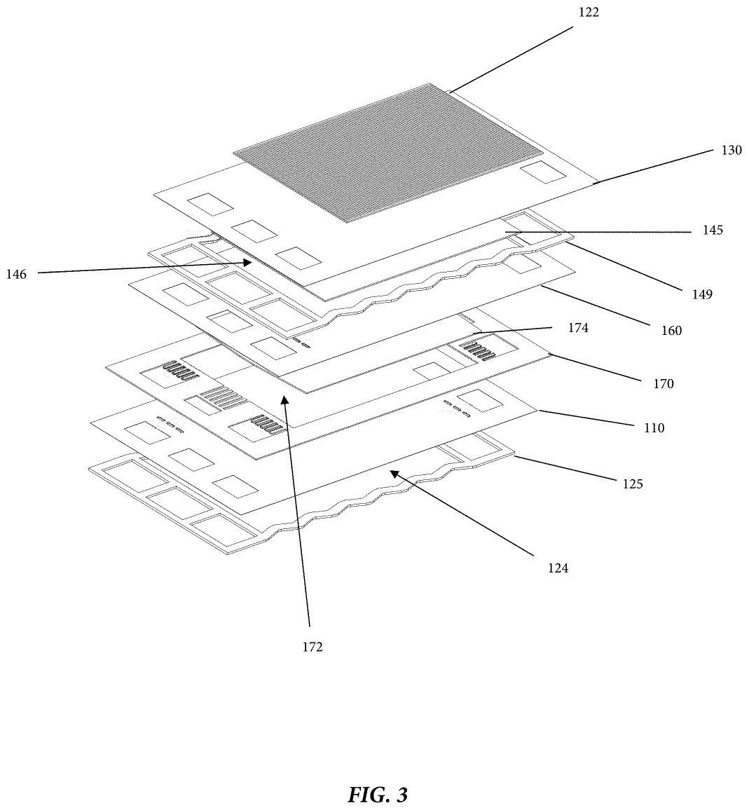

FIG. 3 depicts internal subassembly 100 in an exploded view similar to FIG. 2 except that the seals (i.e., seal 120 and seal 150) differ as described below, and cathode plate separator 110 is depicted below anode plate separator 160 instead of above the anode plate separator, with such depiction illustrating that the elements may be repeated for a full fuel cell stack (e.g., fuel cell stack 20).

Gas diffusion layer 145 may be received in an opening 146 of a gas diffusion layer seal 149 which may be formed of a nonconductive material, such as an elastomer. A coolant frame 170 may have an opening 172 for receiving a conductive porous coolant layer 174 (e.g., a screen or mesh or conductive felt). Gas diffusion layer 122 may be received in an opening 124 of a seal 126—with seal 126 and diffusion layer 122 depicted on opposite ends of the subassembly to show the repeating nature of the elements, but which would be located in a similar manner to that depicted for gas diffusion layer 145 and seal 149.

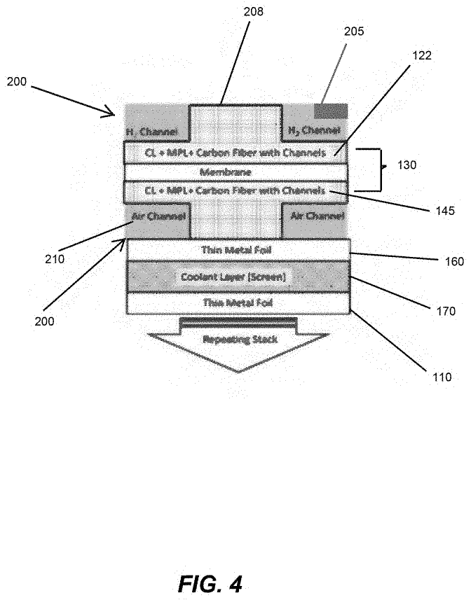

FIG. 4 depicts a close up schematic view of subassembly 100 including plate separator 160 coolant layer 174 received in coolant frame (FIG. 3), and plate separator 110 located in a similar manner as FIG. 3. Membrane electrode assembly 130 is located between gas diffusion layer 122 and gas diffusion fusion layer 145.

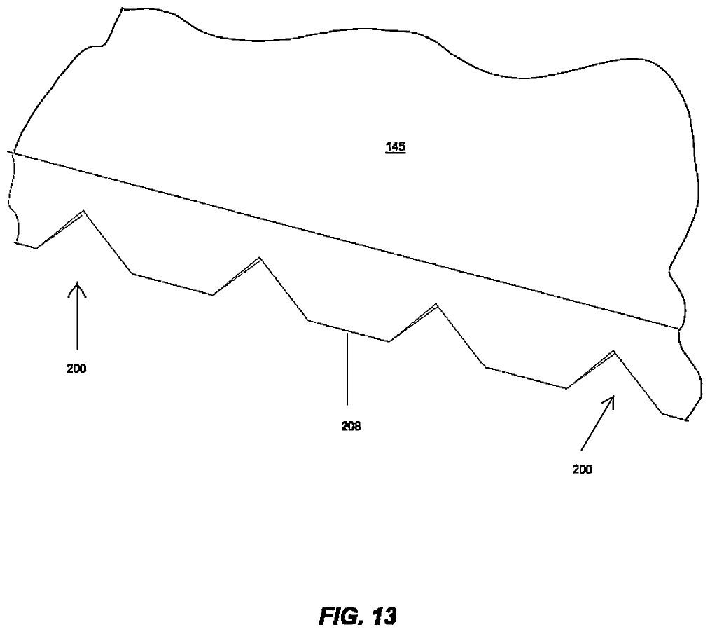

Gas diffusion layer 122 and gas diffusion fusion layer 145 may include channels 200 for receiving fuel and oxidant flow therein with the channels bounded by ribs 208 (FIG. 13). The gas diffusion layers (e.g., gas diffusion layer 122, gas diffusion layer 145) may be formed of carbon fiber and may be porous to allow a flow of fuel and oxidant therethrough. The gas diffusion layers (e.g., gas diffusion layer 122, gas diffusion layer 145) may also be formed of other conductive porous substrates, such as a metal foam. Further, the gas diffusion layers gas may be configured stiff enough to support compressive loads and conductive, so as to minimize bulk and contact resistance.

Gas diffusion layer 122 may include fuel channels 205 (of channels 200) for receiving hydrogen while gas diffusion layer 145 may include oxidant channels 210 (of channels 200) for receiving oxygen, such that electricity may be generated via reaction at membrane electrode assembly 130. Such channels (i.e., channels 200) being present in the gas diffusion layers (e.g., gas diffusion layer 122 and gas diffusion fusion layer 145) instead of the plate separators (e.g., plate separator 110 and plate separator 160) allow the separators to be made of a thin metal foil, such as aluminum, in contrast to prior art plate separators made of stamped stainless steel. More particularly, the metal used for such separator plates may be thinner than previous stamped separators, non-stamped and formed of aluminum instead of stainless steel due to the presence in the gas diffusion layers of the flow channels for the flow of fuel and oxidant where such channels would be formed in the metal separator plates of the prior art. The separators (e.g., plate separator 110 and plate separator 160) may further be treated or coated with a coating (e.g., a metal oxide or gold coating) to inhibit corrosion when subjected to an oxidant and/or fuel when such separators are formed of aluminum, for example. The flat and non-stamped nature of the separators may minimize issues with coatings which occur when coated metals are stamped, or coatings are applied to stamped metal, where the flat separators would have fewer defects and minimize or eliminate damage due to stamping. The areas where plates are stamped in such prior art stamped separators are undesirable because they are known nucleation points for corrosion. The non-stamped separators (e.g., plate separator 110 and plate separator 160) described could further be formed of aluminum, stainless steel, titanium, nickel, or a graphite composite, for example.

Further, the porous nature of channel ribs 208 separating channels 200 of the gas diffusion layers (e.g., gas diffusion layer 122 and gas diffusion fusion layer 145) will not limit diffusion therethrough thereby providing a reduction in reactant transport resistance that is typically observed with conventional flow fields with solid ribs. Although reduced reactant transport resistance is typically observed with porous flow fields, the current invention introduces a uniform convective path for water removal that channel flow fields provide (e.g., in channels 200).

Fuel cell subassembly 100 may be manufactured using a method based on using a web or plastic sheet which connects components of a fuel cell stack (e.g., fuel cell stack 20) during its manufacture. Such web based manufacturing may be more efficient than prior art methods of manufacture which involve more manual methods.

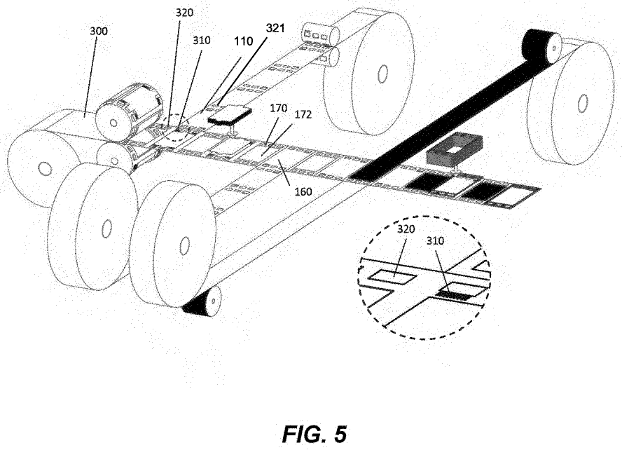

In an example of such a method for manufacturing a fuel cell stack depicted in FIG. 5, a web or plastic sheet 300 may have multiple fuel cell components (e.g., gas diffusion layers, separators, membrane electrode assemblies) formed thereon or attached thereto. Such components may be formed on the web as the web moves from a particular manufacturing location to another location where different processes are performed at such different locations. The components may then be assembled to form a fuel cell stack (e.g., fuel cell stack 20).

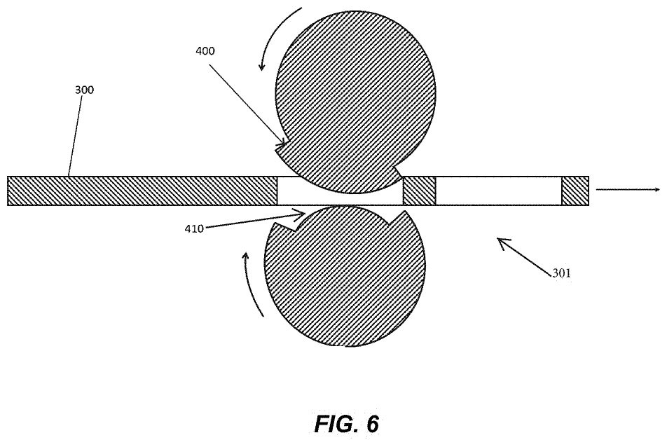

FIG. 6 depicts a side view of web 300 including a forming of various features on web 300, e.g., by cutting the web via a cutting punch 400 and a cutting die 410 with web 300 therebetween. For example, cutting die 400 may cut flow channels 310 (FIG. 5) and dive through conduits 320 (FIG. 5) in web 300 to allow a flow of hydrogen and/or oxidant in a direction parallel to a plane or longitudinal dimension of web 300 or perpendicular thereto. Further, openings, such as opening 172 in frame 170 may be cut to receive fuel cell components, for example.

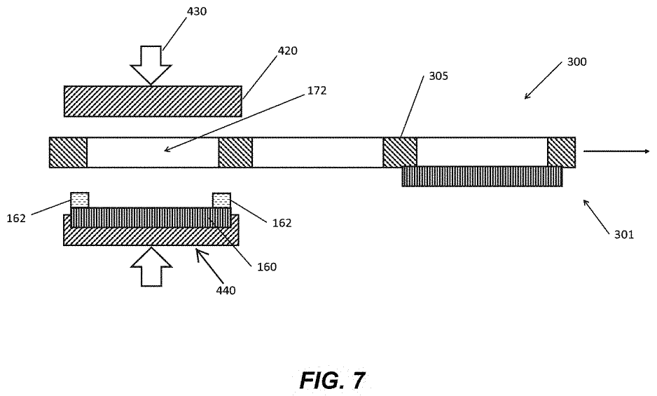

As depicted in FIG. 7, separator 160 may be attached to a bottom 301 of web 300 utilizing a printed adhesive 162, or another such attachment mechanism, below opening 172. A platen 420 and a clamp 430 may hold a top 305 of web 300 while an alignment fixture 440 may hold separator 160 during such attachment process.

As depicted in FIG. 5, the separators (e.g., separator 110 and separator 160) may be formed separately, or cut from a roll, before being connected to web 300 in the process depicted. Such separate creation may include the creation of dive through conduits 321 and other features to allow functional engagement (e.g., flow of fluids) with other components of a fuel cell stack. Further, the separators may be treated or coated (e.g., with a metal oxide, gold coating, or other corrosion resistant thin film) to inhibit corrosion due to an exposure of the separators to oxidants, fuels and water present in a fuel cell environment. A manufacturing line to create such separators may be aligned perpendicular to a longitudinal dimension of web 300 to facilitate a transfer of completed separators to web 300.

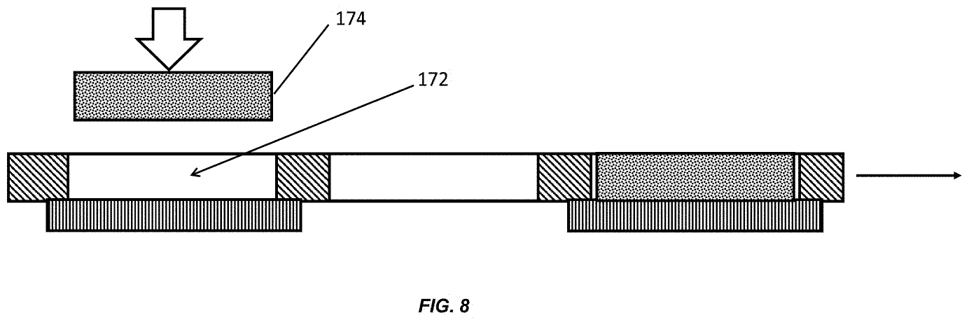

As depicted in FIG. 8, coolant layer 174 may be received in opening 172 of web 300. Such coolant layer may be formed separately (e.g., via a manufacturing line aligned perpendicular to the longitudinal dimension of web 300) and may be deposited in opening 172 via an automatic or manual placement mechanism (e.g., a pick and place robot). [Coolant layer 174 may be a conductive porous material, such as an aluminum mesh or a porous carbon fiber utilized to recirculate a flow of coolant therethrough to maintain an appropriate temperature of assembly 100 and a fuel cell stack (e.g., fuel cell stack 20) of which the assembly is a part.

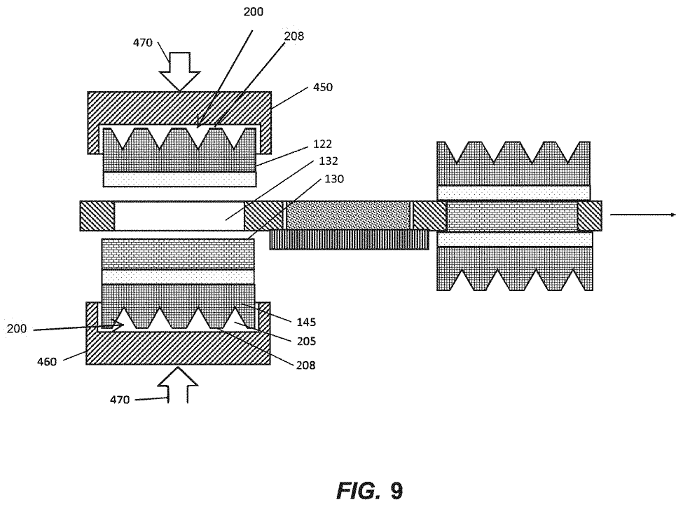

As depicted in FIG. 9, gas diffusion layer 122 may be attached to top 305 of web 300 and gas diffusion layer 145 previously attached to membrane electrode assembly 130 [may be attached to bottom 301 of web 300 such that an opening 132 is therebetween. Membrane electrode assembly 130 may be received in such opening with the gas diffusion layers being attached to web 300

For example, the anode and cathode GDLs (e.g., gas diffusion layer 122, gas diffusion layer 145) may be coated with corresponding catalyst layers (e.g., cathode side catalyst layer 125 and anode side catalyst layer 135) and then the membrane (e.g., membrane 140) may be laminated on top of the anode GDL (e.g., gas diffusion layer 145)). The membrane electrode assembly (e.g., MEA 130) may be formed by hot pressing the aligned anode and cathode portions to attach the membrane electrode assembly to web 300 Heated platens 450, 460 held by clamps 470 may hold the gas diffusion layers (gas diffusion layer 122, gas diffusion layer 145) and the membrane electrode assembly 130 while bonding (e.g., via heat sensitive adhesive or bonding portions of the opposite gas diffusion layers to each other) occurs to web 300.

As indicated above, the gas diffusion layers (gas diffusion layer 122, gas diffusion layer 145) may include channels 200 and may be formed to include such channels in a manufacturing line which is perpendicular to the direction of web 300 such that a gas diffusion layer may be readily attached to a membrane electrode assembly (e.g., membrane electrode assembly 130) and moved from such perpendicular manufacturing line to web 300. Such grooves may be created in the gas diffusion layers using a groove cutting tool, for example. Alternatively, material may be added during a carbon fiber manufacturing process.

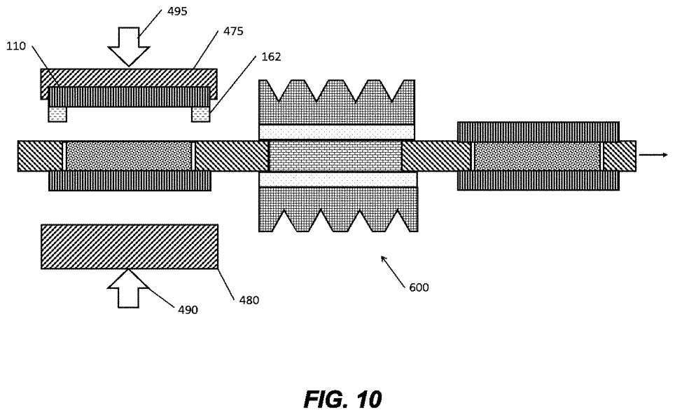

As depicted in FIG. 10, separator 110 may be attached to top 305 of web 300 utilizing a printed adhesive 162, or another such attachment mechanism, above an opening (e.g., opening 172) in web 300. A platen 480 and a clamp 490 may hold separator 160 and bottom 301 of web 300 while an alignment fixture 475 and clamp 495 may hold plate 110 during such attachment process. The attachment of separator 110 to web 300 and separator 160 forms a first subassembly 600.

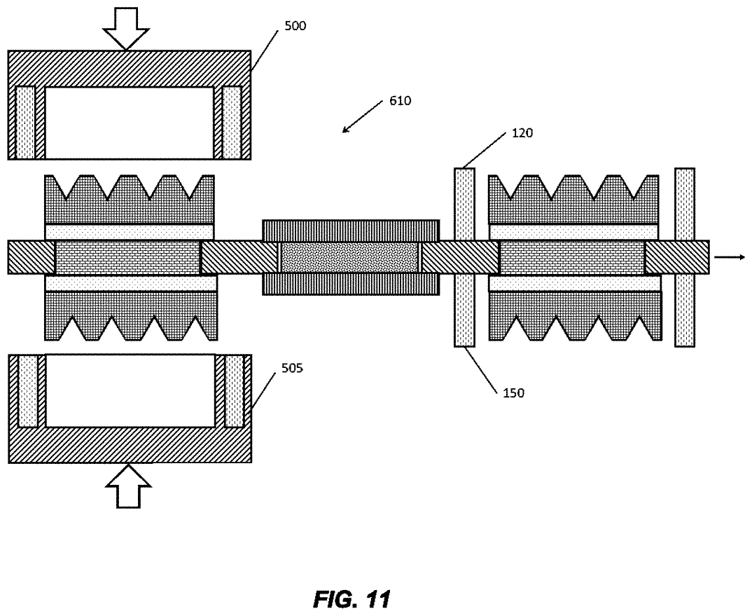

A seal may be located in one or more locations along web 300 as depicted in FIG. 11. For example, seal 120 and seal 150 (FIG. 2) may be formed by injection molding on opposite sides of web 300 about the gas diffusion layers and membrane electrode assembly (e.g., gas diffusion layer 145, gas diffusion layer 122, and membrane electrode assembly 130) using a mold die 500 and a mold die 505. The formation of the seals (e.g., seal 120 and seal 150) on the gas diffusion layers and membrane electrode assembly forms a second subassembly 610.

As described above, various fuel cell components may be formed on, and/or connected to, web 300 including first subassembly 600 and second subassembly 610. These subassemblies may be continuously repeated on web 300 such that web 300 may be utilized as a base for an efficient manufacturing process. For example, web 300 may be cut perpendicular to a longitudinal dimension thereof such that the multiple instances of such indicated subassemblies may be separated from one another and assembled into a fuel cell stack (fuel cell stack 20). Alternatively, web 300 may partially or completely remain intact longitudinally after such assembly of a fuel cell stack.

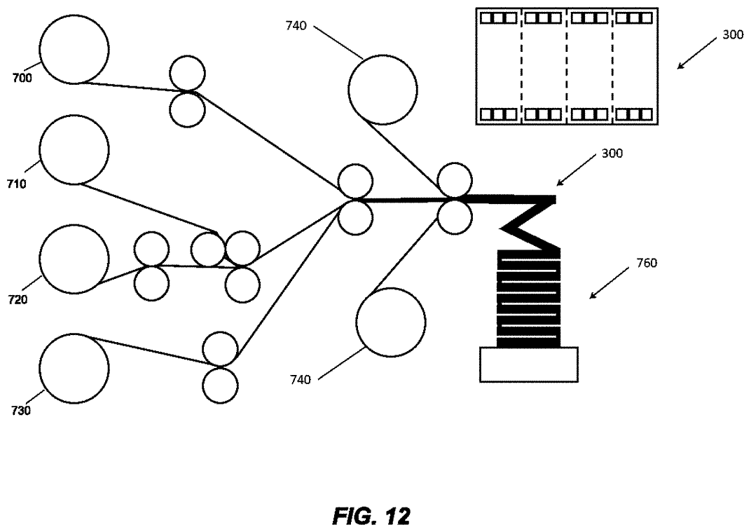

FIG. 12 illustrates a schematic example of a process for manufacturing using the above steps in forming subassemblies (e.g., first subassembly 600 and second subassembly 610) where a metal foil roll 700, a mesh roll 710 (e.g., for forming coolant layer 174), a plastic (e.g., PET) sheet roll 720 and a second foil metal roll 730 (e.g., for forming separators 110 and 160) may be utilized as inputs to the process. Further, rolls of gas diffusion layers 740 (e.g., for forming gas diffusion layer 145, gas diffusion layer 122), one of which may include a membrane electrode assembly (e.g., for forming instances of membrane electrode assembly 130) attached thereto may also be utilized. The rolls of inputs (e.g., metal foil roll 700, mesh roll 710, second foil metal roll 730, PET roll 720, rolls of gas diffusion layers 740) may thus be utilized in a manufacturing line in the manner described above such that a plurality of subassemblies (e.g., instances of subassembly 600 and sub assembly 610) may be output on a continuous roll 760 prior to being cut to separate particular fuel cell components or subassemblies (e.g., e.g., first subassembly 600 and second subassembly 610) to form fuel cell stack(s) as described above. In some instances, a cutting of web 300 after an output of such subassemblies may not be necessary since the continuous web (e.g., web 300) may be incorporated entirely into a fuel cell (fuel cell stack 20).

While several aspects of the present invention have been described and depicted herein, alternative aspects may be affected by those skilled in the art to accomplish the same objectives. Accordingly, it is intended by the appended claims to cover all such alternative aspects as fall within the true spirit and scope of the invention.

1. A fuel cell system comprising:
a first electrically non-conductive sheet portion having a coolant flow layer in a first opening thereof;
a first non-stamped, flat, metal separator on a first side of said coolant flow layer;
a second non-stamped, flat, metal separator on a second side of said coolant flow layer opposite said first separator;
a membrane received in an opening of a second electrically non-conductive sheet portion;
gas diffusion layers on opposite sides of said membrane, said gas diffusion layers having channels open toward said first non-stamped, flat, metal separator or said second non-stamped, flat, metal separator to allow flow of an oxidant and/or a fuel therethrough.

2. The system of claim 1 wherein said first metal separator and said second metal separator comprise metal foil plates coated to inhibit corrosion due to the fuel and/or the oxidant and/or a coolant and/or contaminates and/or reaction products.

3. The system of claim 1 wherein said gas diffusion layers are porous to a fuel and/or an oxidant to allow a flow therethrough for generating electricity at the membrane.

4. The system of claim 1 wherein said first metal separator and said second metal separator are bonded to said first non-conductive sheet portion;

5. The system of claim 1 wherein said gas diffusion layers are bonded to the second non-conductive sheet portion on opposite sides of the membrane.

6. The system of claim 1 wherein said coolant layer comprises a conductive porous material received in a coolant opening of said electrically non-conductive sheet portion to allow a flow of coolant therethrough to control a temperature of the system.

7. A fuel cell subassembly for use in forming a fuel cell stack comprising:
an electrically non-conductive sheet;
a plurality of fuel cell component locations linearly spaced on said sheet;
a first location of the plurality of fuel cell component locations comprising:
a first sheet portion of the sheet with a first opening and a metal separator on a first side of said sheet covering said opening;
a coolant flow layer received in said first opening at the first location;
a second metal separator on a second side of said sheet covering said first opening;
a second location of the plurality of fuel cell component locations comprising:
a membrane received in a second opening of the sheet;
a first gas diffusion layer located on a first side of the second opening and a second gas diffusion layer located on a second side of the second opening.

8. The subassembly of claim 7 wherein said first separator and said second separator are connected to said sheet at said first location and said first gas diffusion layer and said second gas diffusion layer are connected to said sheet at said second location.

9. The subassembly of claim 7 wherein said first metal separator and said second metal separator comprise metal foil plates coated to inhibit corrosion due to a fuel and/or a oxidant and/or a coolant and/or contaminates and/or reaction products.

10. The subassembly of claim 7 wherein said first metal separator and said second metal separator comprise flat, non-stamped metal plates.

11. The system of claim 7 wherein said gas diffusion layers comprise channels open facing away from said membrane to allow flows of oxidant and fuel therethrough.

12. The system of claim 7 wherein said gas diffusion layers are bounded by ribs porous to a fuel and/or oxidant to allow a flow therethrough for generating electricity at the membrane.

13. The system of claim 7 wherein said coolant flow layer comprises a conductive porous mesh flow layer.

14. A method for use in manufacturing a fuel cell system comprising:
forming a plurality of openings in an electrically non-conductive sheet, the openings linearly spaced on the sheet;
locating a first metal separator on a first side of the sheet covering a first opening of the plurality of openings in a first sheet portion of the sheet;
locating a coolant flow layer in the first opening;
locating a second metal separator on a second side of the sheet covering the first opening;
locating a membrane in a second opening of the plurality of openings in a second sheet portion of the sheet;
locating a first gas diffusion layer on a first side of the second opening and a second gas diffusion layer located on a second side of the second opening.

15. The method of claim 14 further comprising connecting the first separator and the second separator to the sheet at the first opening and the first gas diffusion layer and the second gas diffusion layer to the sheet at the second opening.

16. The method of claim 14 wherein the first metal separator and the second metal separator comprise flat aluminum foil plates, and further comprising coating the first metal separator and the second metal separator with a coating to inhibit corrosion due to a fuel and/or an oxidant and/or a coolant contacting the first metal separator and the second metal separator.

17. The method of claim 14 wherein the first gas diffusion layer and the second gas diffusion layer comprise channels facing the first metal separator or the second metal separator to allow flows of oxidant and fuel therethrough.

18. The method of claim 14 wherein the first gas diffusion layer and the second gas diffusion layer comprise ribs bounding channels, said ribs porous to a fuel and/or oxidant to allow a flow therethrough for generating electricity at the membrane.

19. The method of claim 14 wherein the coolant flow layer comprises a conductive porous mesh flow layer.

20. The method of claim 14 further comprising forming a seal on the first metal separator or the sheet via an injection molding process.

21. A method for use in manufacturing a fuel cell system comprising:
forming an opening in an electrically non-conductive sheet;
locating a first metal separator on a first side of the sheet covering the opening in a first sheet portion of the sheet;
locating a coolant flow layer in the first opening;
locating a second metal separator on a second side of the sheet covering the opening.
